(19) United States
(12) Patent Application Publication
(10) Pub. No.: US 2026/0055660 A1
(43) Pub. Date: Feb. 26, 2026

(54) System and Method for Dynamic Masking

(71) Applicant: Arup IP Management, Ltd., London (GB)

(72) Inventors: Edward Arenius, Greenwood Lake, NY (US); Alexander Colodner, San Diego, CA (US); Rajesh Patel, Brooklyn, NY (US); Joshua Michael Cushner, Alameda, CA (US)

(73) Assignee: Arup IP Management, Ltd., London (GB)

(21) Appl. No.: 19/248,832

(22) Filed: Jun. 25, 2025

Related U.S. Application Data
(60) Provisional application No. 63/663,716, filed on Jun. 25, 2024.

(51) Int. Cl. E06B 9/70; E06B 9/40; E06B 9/80

(52) U.S. Cl. CPC E06B 9/70; E06B 9/40; E06B 9/80; E06B 2009/801

(57) ABSTRACT

The present invention introduces a mechanical device designed for two-way continuous surface masking offers enhanced functionality when integrated with an external sensor system. This device comprises masking systems capable of adjustable apertures, offering versatility in spatial arrangement. Adaptation of the device's configuration is facilitated by automated cues or inputs from environmental sensors, enabling dynamic and efficient surface masking. Additionally, the system can be scaled to accommodate multiple apertures over a single surface. Its applications span various sectors, including residential, commercial, industrial, media, marketing, production, and performance environments.

### CROSS-REFERENCE TO RELATED APPLICATIONS

This application is a U.S. Non Provisional Patent Application which claims priority to co-pending U.S. Provisional Patent Application No. 63/663,716 , filed on Jun. 25, 2024, the contents of which is hereby fully incorporated by reference.

### FIELD

This invention relates to mechanical apparatuses utilized for masking surfaces, including those found on interior or exterior walls or ceilings. More precisely, it introduces a system that integrates continuous automated masking with adjustable apertures, offering the capability for external sensor control to facilitate adaptive positioning in response to environmental conditions or other sensory inputs.

### BACKGROUND

In various architectural, interior design, event, and production contexts, there arises a demand for flexible surface masking solutions. Current approaches often rely on fixed screens or curtains, which impose constraints on adaptability. In an example, using fixed curtains as a masking solution presents several limitations and challenges in various applications. Firstly, fixed curtains lack adaptability, unable to easily adjust to different environmental conditions or requirements. For example, in theaters, fixed curtains may not adequately accommodate changes in lighting or stage configurations during different acts or performances. Secondly, fixed curtains offer inflexible aperture control, typically having predetermined openings that may not align with specific spatial or design needs. This lack of flexibility can restrict creative expression or functional requirements. In conference rooms, fixed curtains may not allow precise control over the size and placement of the opening needed for projection screens or presentations. Additionally, fixed curtains often lack versatility in meeting diverse needs. In scenarios requiring multiple functions, such as event spaces or production studios, fixed curtains may fall short in providing necessary adaptability and functionality. Maintenance also poses a challenge, as fixed curtains may require regular cleaning and upkeep, especially in environments with high levels of dust or moisture. Over time, accumulated dirt or damage may affect the appearance and performance of the curtains, leading to additional costs and inconvenience. Lastly, fixed curtains may have limited aesthetic appeal or design flexibility, particularly in settings where visual aesthetics play a significant role, such as luxury hotels or themed entertainment venues. In these spaces, the inability to customize the appearance or adjust the curtains according to evolving design trends or branding requirements can detract from the overall ambiance and appeal. Thus, while fixed curtains may offer simplicity and cost-effectiveness in some situations, their inherent limitations underscore the need for more innovative and versatile surface masking solutions.

Existing surface masking solutions primarily revolve around adjusting the aspect ratio of projected images to fit different media formats, such as 16:9, 1.85:1 widescreen, or anamorphic 2.39:1 widescreen. However, these solutions face several limitations. Firstly, they often lack the capability to achieve complete closure, meaning they cannot fully block out light or visuals when needed. For instance, in a home theater setting, existing masking systems may struggle to provide total darkness during daytime viewing, leading to reduced image quality and viewer experience. Additionally, these systems often lack precision in positioning and sizing the aperture within the masking system's frame. This limitation can impact the effectiveness of the masking process, particularly in environments where precise control over the viewing area is crucial, such as in professional theaters or presentation venues. Furthermore, existing surface masking solutions exhibit limited adaptability to changing environmental conditions. For example, in a conference room with varying lighting conditions throughout the day, conventional masking systems may not be able to dynamically adjust to optimize visibility or enhance the presentation experience. As a result, users may encounter difficulties in achieving the desired visual outcome or may need to resort to manual adjustments, leading to inefficiencies and disruptions. In summary, while existing surface masking solutions offer some degree of flexibility in accommodating different media formats, their inability to achieve complete closure, lack of precision in aperture positioning, and limited adaptability to environmental changes highlight the need for more advanced and versatile masking technologies.

Many existing surface masking solutions often lack the capability to provide multiple apertures over a single surface, limiting their versatility and functionality in various applications. This deficiency becomes particularly evident in settings where diverse or dynamic visual configurations are required. For example, consider a conference room used for both presentations and collaborative discussions. In such a space, traditional masking solutions typically offer a single aperture for projection purposes. However, during interactive sessions where multiple presenters need to display content simultaneously, or when participants engage in group discussions while referring to projected materials, a single aperture may prove insufficient. Without the ability to create multiple apertures, attendees may face challenges in viewing and interacting with the content effectively. Similarly, in event venues hosting multimedia performances or installations, the inability to provide multiple apertures can limit the creative possibilities. For instance, an art gallery showcasing interactive digital artworks may require different apertures for each exhibit to ensure optimal visibility and engagement. Without this capability, the curator's ability to curate immersive and dynamic experiences for visitors may be compromised. Moreover, in educational environments such as classrooms or training facilities, existing surface masking solutions may struggle to accommodate diverse teaching methodologies. For instance, in a modern classroom where instructors utilize multimedia content, collaborative activities, and traditional lecturing, a single aperture may not suffice to support various instructional modes simultaneously. As a result, educators may face limitations in delivering engaging and effective lessons tailored to different learning styles and objectives.

Furthermore, in home entertainment settings such as media rooms or gaming spaces, the inability to provide multiple apertures can impact the viewing experience for users. For example, in a family room where members may want to watch different content simultaneously or switch between gaming and movie viewing, a single aperture may restrict flexibility and convenience.

Without the option to create multiple apertures, users may need to compromise on their preferences or invest in additional display devices, leading to increased complexity and cost. In summary, the lack of multiple apertures in existing surface masking solutions poses significant limitations across various settings, including conference rooms, event venues, educational environments, and home entertainment spaces. Addressing this deficiency is essential to enhance versatility, functionality, and user experience in surface masking applications. Thus, there is a need to offer the flexibility to create and control multiple apertures over a single surface to unlock new possibilities for visual communication, collaboration, and immersive experiences in diverse contexts.

### SUMMARY

The present innovation seeks to overcome the limitations of current masking solutions by offering a system with a mechanical device enabling continuous masking with adjustable apertures. A system including the mechanical device for two-way continuous masking of surfaces aims to mitigate many shortcomings by incorporating an external sensor that automatically adjusts the masking system's position based on measured stimuli including, but not limited to, light levels, temperature, occupancy, and/or carbon monoxide (CO2) levels. The mechanical device for two-way continuous masking of surfaces is configured for integrating the capability to stack masking devices back-to-back, thereby enabling the creation of multiple customizable apertures and bidirectional continuous masking while dynamically adapting its setup based on automated cues or environmental triggers. The system is designed to offer flexibility in spatial configuration by accommodating variable aperture sizes or complete closure. The system's modular nature facilitates the creation of multiple apertures over a single surface.

The mechanical device comprises a fixed outer frame, along with vertical and horizontal rods that traverse the frame while simultaneously concealing or revealing a foldable material stretched between each set of rods. A motorized system allows users to adjust the size and position of the unmasked aperture. When fully closed, the device provides comprehensive masking, while when fully open, it offers unobstructed views. The system ensures smooth movement and stability throughout its operation. The choice of material for the device can be tailored to suit specific applications and can be easily replaced as needed. An alternative option for the masking material in the proposed mechanical device is a roll-up tambor-like material, which offers several advantages and applications. This material, similar to what is commonly used in roll-up doors or window blinds, consists of flexible slats or panels that can be rolled up and concealed within a compact housing when not in use. When deployed, the tambor material unfolds smoothly, creating a seamless surface for masking purposes. This type of material is well-suited for applications where space optimization is crucial, such as in compact rooms or areas with limited clearance for bulky masking systems.

Additionally, the roll-up tambor material offers enhanced durability and weather resistance, making it suitable for both indoor and outdoor use. For instance, in outdoor event spaces or exhibition venues, the tambor material can effectively shield projection screens or display areas from adverse weather conditions like wind, rain, or sunlight. Furthermore, the flexibility of the tambor material allows for easy customization to fit various shapes and sizes of surfaces, enabling versatile masking solutions for unconventional or irregularly shaped spaces. In residential settings, the roll-up tambor material can be integrated seamlessly into home automation systems, allowing users to control the masking function remotely or program it to respond to specific triggers or events. Overall, the roll-up tambor material presents a practical and adaptable option for masking applications, offering space-saving design, durability, weather resistance, and versatility across diverse environments and use cases.

In addition, environmental sensors equipped with real-time data collection capabilities can facilitate a “responsive” mode for the masking system, enhancing its adaptability to changing environmental conditions. These sensors encompass a range of functionalities, including measuring stimuli such as light levels, temperature, occupancy, and CO2 levels. For instance, a light level sensor detects variations in ambient light intensity, allowing the masking system to adjust aperture size to optimize visibility while reducing glare. Similarly, a temperature sensor monitors changes in room temperature, enabling the system to regulate aperture size to maintain a comfortable indoor environment. An occupancy sensor detects the presence of individuals in the space, prompting the masking system to adjust aperture size based on occupancy levels. Additionally, a CO2 level sensor measures carbon dioxide concentration, signaling the system to modify aperture size to improve ventilation in response to elevated CO2 levels. By leveraging data from these environmental sensors, the masking system can dynamically adapt its aperture position and size, ensuring optimal performance and user comfort in diverse settings.

In addition to the aforementioned sensors, several other types of sensors could be integrated into the masking system to enhance its functionality and responsiveness to environmental cues. One such sensor is a humidity sensor, which measures the moisture content in the air. By detecting changes in humidity levels, the system can adjust aperture size to maintain optimal comfort levels, particularly in environments prone to humidity fluctuations, such as bathrooms or kitchens. Another useful sensor is a sound level sensor, which monitors noise levels in the surrounding environment. This sensor enables the system to dynamically adjust aperture size based on noise levels, providing acoustic privacy in areas where sound control is crucial, such as offices or conference rooms. Additionally, a motion sensor can detect movement within the space, allowing the system to adjust aperture size or activate the masking system when occupants enter or leave the room. Furthermore, sensors for air quality parameters such as particulate matter (PM) or volatile organic compounds (VOCs) could be incorporated to monitor indoor air quality and trigger aperture adjustments accordingly, ensuring a healthy and comfortable environment. By integrating these various sensors into the masking system, it can respond effectively to a wide range of environmental factors, providing adaptive and user-centric functionality across diverse settings.

Multiple devices within the masking system can be stacked together back-to-back, offering a flexible solution to create multiple apertures over a single surface. This stacking capability enhances the system's versatility and adaptability, allowing it to accommodate diverse spatial configurations and requirements in various settings. For example, in a large conference room or auditorium, multiple masking devices can be stacked to create multiple apertures along a single wall or partition. Each aperture can be independently controlled, enabling customized lighting and visibility options for different sections of the space. Similarly, in a retail environment, stacked masking devices can create dynamic displays with adjustable apertures to showcase products or promotional materials.

Furthermore, in residential settings, stacked masking devices can be utilized to partition open-plan living spaces, providing privacy when needed while maintaining an open layout at other times. By offering the flexibility to stack devices and create multiple apertures, the masking system adapts seamlessly to various spatial configurations and functional requirements, enhancing its utility and usability across different applications and environments.

When the devices are stacked back-to-back, they are positioned so that the backside of one device is in contact with the backside of another device. This configuration allows for efficient use of space and enables the creation of multiple apertures over a single surface. Essentially, stacking involves placing one device directly above or below another to maximize functionality and versatility while minimizing footprint. In a horizontal orientation, “stacked” refers to arranging multiple devices side by side in a row, with each device positioned directly adjacent to the next one. This configuration allows for easy access to each individual device while maximizing the use of available horizontal space. In a vertical orientation, “stacked” involves arranging multiple devices on top of each other, with one device positioned directly above another. This configuration is commonly used when space is limited or when it is desirable to create a vertical column of devices. Stacking devices vertically allows for efficient use of vertical space while still providing access to each device in the stack.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 is a diagram illustrating an example of a masking system with one or more panels disposed at a surface of a substrate of a window in various stages of deployment in accordance with some embodiments.

FIG. 2 is a diagram illustrating an example of the masking system of FIG. 1 with one or more panels disposed at a surface of a display of an electronic device in a partially deployed stage in accordance with some embodiments.

FIG. 3 is a diagram illustrating an example of the masking system of FIG. 1 with one or more panels disposed at a surface of an object in various stages of deployment in accordance with some embodiments.

FIG. 4 illustrates a cross-sectional side view of the masking system of FIG. 1 for use over a surface implementing a plurality of masking devices stacked back-to-back in accordance with some embodiments.

FIG. 5 illustrates a front elevation view of the masking system of FIG. 4 for use over a surface implementing a plurality of masking devices stacked back-to-back in accordance with some embodiments.

FIG. 6 illustrates a front elevational view of an embodiment of a masking system with one or more curved panels oriented to form a curved aperture in accordance with some embodiments.

FIG. 7 illustrates a top perspective view of the masking system of FIG. 6 with one or more curved panels oriented to form a curved aperture in accordance with some embodiments.

### DETAILED DESCRIPTION

It is to be understood that the figures and descriptions provided herein may have been simplified to illustrate aspects that are relevant for a clear understanding of the herein described processes, machines, manufactures, and/or compositions of matter, while eliminating, for the purpose of clarity, other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

It will be readily understood that the components of the present invention, as generally described and illustrated in the figures herein, may be realized in a variety of different configurations. Thus, the following detailed description of the embodiments of a method, apparatus, and system, as represented in the attached figures, is not intended to limit the scope of the invention as claimed, but is merely representative of selected illustrative embodiments of the invention. The usage of the phrases “example embodiments,” “some embodiments,” or other similar language, throughout this specification refers to the fact that a particular feature, structure, or characteristic described in connection with the embodiment may be included in at least one embodiment of the present invention, and do not necessarily all refer to the same group of embodiments.

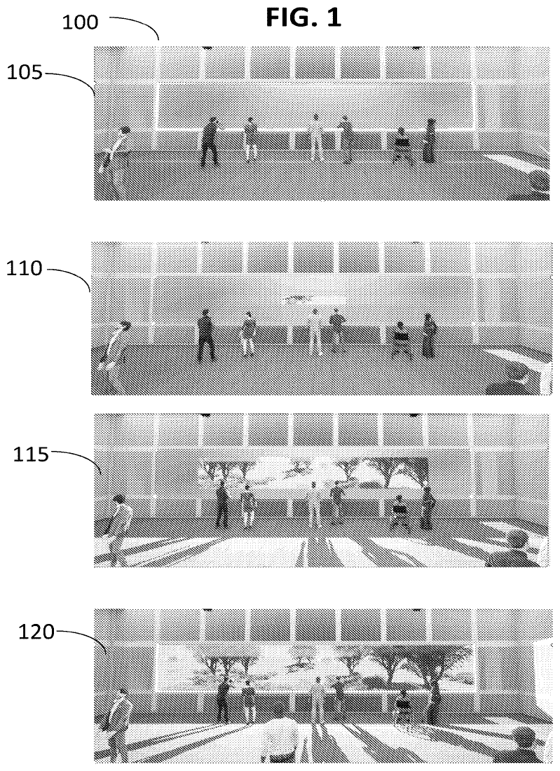

FIGS. 1-5 illustrate example configurations, structures, and processes to implement masking system that includes one or more linear actuators each comprising a frame with perpendicular first and second tracks, a motor connected to a power source, a first rod traversing the first track with a first panel attached, a second rod traversing the second track with a second panel attached, a positioning sensor controlling the motor's position, and a computing device connected to the positioning sensor and power source. The motor reciprocates the first rod along the first track. Environmental sensors are connected to the positioning sensor. The system provides precise control over the positioning of the panels for effective masking in various applications.

FIG. 1 is a diagram illustrating an example of a masking system 100 with one or more panels disposed at a surface of a substrate, such as a transparent material such as glass and/or resin, of a window in various stages of deployment accordance with some embodiments. At block 105, the panels are expanded to overlay the surface of the window completely. At block 110 and block 115, the panels are partially retracted to allow a larger viewing area of the window. At block 120, the panels are completely retracted to expose the viewing window.

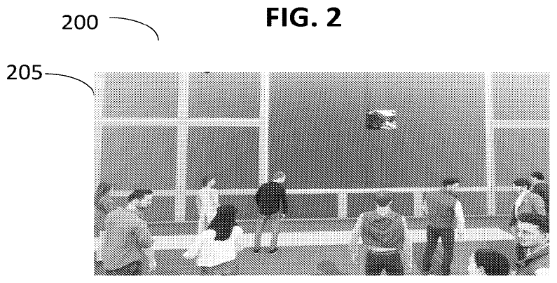

FIG. 2 is a diagram illustrating an example of a masking system 200 with the one or more panels of FIG. 1. At block 205, the panels are disposed at a surface of a display of an electronic device such as a television or a computer monitor screen in a partially deployed stage accordance with some embodiments.

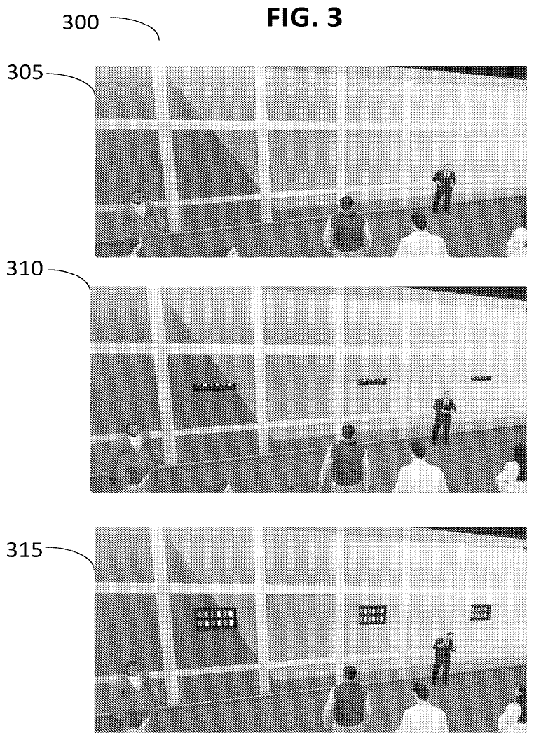

FIG. 3 is a diagram illustrating an example of a masking system 300 with the one or more panels of FIGS. 1 and 2 in a stacked configuration and disposed at a surface of an object in various stages of deployment accordance with some embodiments. At block 305, the panels are expanded to overlay the surface of the object, such as a consumer product, completely. At block 310, the panels are partially retracted to allow a larger viewing area of the surface of the object. At block 315, the panels are completely retracted to expose the surface of the object.

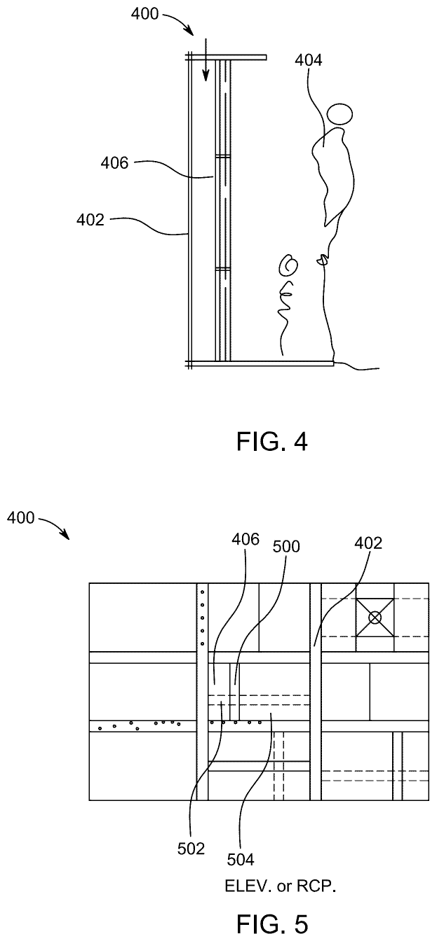

FIG. 4 illustrates another example of a masking system 400 for use overlaying and/or disposed at a surface 404. The masking system 400 implements a plurality of masking devices 406 stacked back-to-back in accordance with some embodiments. The items, structures, and/or objects being overlaid by the masking device include, but are not limited to, any surface 404. This term surface 404 encompasses various objects and/or structures such as windows, walls, ceilings, screens, and products that can be covered and/or concealed by the masking system 400. The masking system 400 is comprised of several structural components designed to facilitate its functionality such as a fixed outer frame 402, serving as the foundational structure to support the entire system.

FIG. 5 illustrates the masking system 400 of FIG. 4 implementing a plurality of masking devices 406 stacked back-to-back in accordance with some embodiments. Integrated within the frame 402 are one or more vertical rods 500 and one or more horizontal rods 502 that are capable of sliding across the frame 402. These rods concurrently conceal and/or reveal a foldable material 504 that is stretched between at least each set of one or more horizontal rods 502 and one or more vertical rods 500. This foldable material 504 acts as the masking surface, which can be adjusted to create variable apertures.

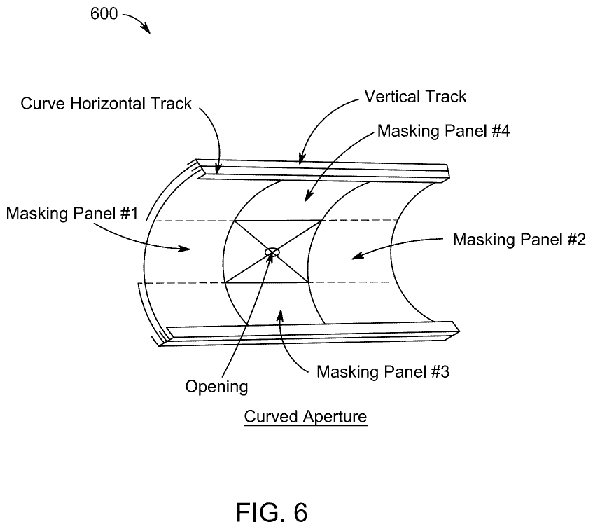

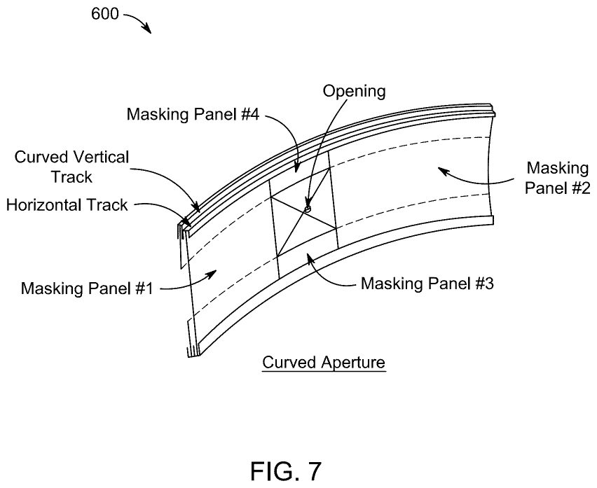

FIGS. 6 and 7 illustrates an example embodiment of a masking system 600 with one or more curved panels oriented to form a curved aperture. All of the uses identified in FIGS. 1-5 may incorporate curved surfaces as identified in this document. For example, the vertical and horizontal planes may have a radiused curvature and only one plane can be curved at any given time, allowing for flexibility within the masking system 600. However, the moving edges should maintain perpendicularity to each other for the system to function properly.

In some aspects, the techniques described herein relate to a masking system, including: one or more linear actuators, including: a frame with a first track oriented perpendicular to a second track; and, a motor connected to a power source; a first rod with an end to slidably traverse the first track; a first panel connected to the first rod a second rod with an end to slidably traverse the second track; a second panel connected to the second rod; a positioning sensor electrically connected to the motor, the positioning sensor is configured to control the position of the motor, the motor is configured to drive the one or more linear actuators to reciprocate the first rod along at least a portion of the first track; a computing device, the computing device is electrically connected to the positioning sensor of the motor, the computing device is electrically connected to the power source; and one or more environmental sensors electrically connected to the positioning sensor.

In some aspects, the techniques described herein relate to a masking system wherein the first rod and the second rod are not coplanar.

In some aspects, the techniques described herein relate to a masking system wherein a physical location of the first track is offset from the second track.

In some aspects, the techniques described herein relate to a masking system wherein the motor is configured to drive the one or more linear actuators to reciprocate the second rod along at least a portion of the second track concurrently with the first rod along at least a portion of the first track.

In some aspects, the techniques described herein relate to a masking system wherein the one or more environmental sensors is a light sensor to measure ambient light.

In some aspects, the techniques described herein relate to a masking system wherein the one or more environmental sensors is a motion sensor.

In some aspects, the techniques described herein relate to a masking system wherein the one or more environmental sensors is a temperature sensor.

In some aspects, the techniques described herein relate to a masking system wherein the one or more environmental sensors is a carbon dioxide sensor to detects and measures a concentration of carbon dioxide gas.

In some aspects, the techniques described herein relate to a masking system wherein the first panel and the second panel are made of a flexible material configured to be stretched

In some aspects, the techniques described herein relate to a masking system wherein the first panel and the second panel are made of a rollable material configured to be rolled.

In some aspects, the techniques described herein relate to a masking system further including: a locking mechanism configured to connect a first frame of a first linear actuator of the one or more linear actuators to a second frame of a second linear actuator of the one or more linear actuators.

The masking system provides continuous masking of surfaces with adjustable aperture size and position, augmented by an external sensor for adaptive positioning. In this system, adaptive refers to the capability of adjusting the size and position of the masking apertures based on external factors or inputs from sensors. In this system, dynamic denotes the system's ability to respond and adapt in real-time to changing environmental conditions or user preferences. The set of rods in the masking system exhibits adaptive and dynamic characteristics through their ability to adjust the size and position of the masking apertures in response to changing conditions or user requirements. This adaptability is facilitated by the motorized track or rail system to which the rods are affixed, allowing for smooth movement and control. The system can dynamically slide the rods horizontally or vertically to create different aperture configurations, enabling the masking to be tailored to specific needs or environmental conditions. Additionally, locking mechanisms ensure stability once the desired configuration is achieved, enhancing the system's adaptability and reliability.

The rods in this configuration are non-coplanar. The structural layout involves a frame featuring a first track positioned perpendicular to a second track, with the physical location of the first track intentionally offset from the second track. The rods, each equipped with an end for traversing its respective track, would not lie within the same plane. As the first track intersects the second track at a right angle and their physical positions are intentionally misaligned, the rods sliding along these tracks would be situated in different planes.

Constructed from lightweight and durable materials such as aluminum, plastic, wood, or composite, individual rods span the intended distances of the frame, providing structural support.

Affixed to a motorized track or rail system, these rods ensure smooth movement across the frame. A foldable material is stretched across the rods in each direction, allowing them to roll the material as they slide. A control mechanism, whether manual or motorized, enables users or automated sensors to adjust the position of the panels, offering flexibility in aperture configuration. In an example, a motorized system is incorporated into the device to enable users to control the size and position of the unmasked aperture. This motorized mechanism provides a means for adjustments, allowing users to tailor the masking configuration according to their specific needs and preferences. Together, these structural components form a cohesive system that offers flexibility and adaptability in surface masking applications.

In an implementation, a motor is integrated and configured to drive a linear actuator. The linear actuator serves the purpose of reciprocating the first rod, enabling it to traverse along its designated track. This motor-driven mechanism facilitates controlled movement of the first rod, allowing it to slide back and forth along the track in a reciprocating motion. The linear actuator translates the rotational motion generated by the motor into linear motion, precisely controlling the displacement of the first rod along its path.

Operationally, users can slide the rods horizontally or vertically to create desired apertures, with the masking capable of overlapping partially or fully as needed. Locking mechanisms ensure stability once the desired configuration is achieved. The device finds applications across a spectrum of settings, including residential and commercial spaces for partitioning rooms, theaters, and conference halls for controlling acoustics and visibility, museums and galleries for customizing exhibit spaces, and hospitals and clinics for adapting patient rooms or treatment areas. It also serves in education for flexible classroom setups and in marketing, events, productions, and shows for dynamic advertising and immersive experiences. Additionally, it can optimize ventilation, lighting, and acoustics, maintaining environmental conditions through control of airflow, daylight, artificial light, and sound.

The integration of environmental sensors enhances the system's adaptability and automation. These sensors, strategically placed according to the use case, continuously monitor environmental conditions. Based on sensor inputs, the control mechanism adjusts the position of the panels in real-time. For instance, in low light conditions, panels automatically open to allow more natural light, while in high light situations, they close partially or fully to reduce glare. The system can also adapt based on factors such as room occupancy, temperature, and sound levels. This integration extends its applications into areas like smart homes and offices for integration with home-scale automation systems, healthcare facilities for patient comfort optimization, and marketing and events for dynamic advertising and production needs.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A masking system, comprising:
one or more linear actuators, comprising:
a frame with a first track oriented perpendicular to a second track; and,
a motor connected to a power source;
a first rod with an end to slidably traverse the first track;
a first panel connected to the first rod a second rod with an end to slidably traverse the second track;
a second panel connected to the second rod;
a positioning sensor electrically connected to the motor, the positioning sensor is configured to control the position of the motor, the motor is configured to drive the one or more linear actuators to reciprocate the first rod along at least a portion of the first track;
a computing device, the computing device is electrically connected to the positioning sensor of the motor, the computing device is electrically connected to the power source; and
one or more environmental sensors electrically connected to the positioning sensor.

2. The masking system of claim 1 wherein the first rod and the second rod are not coplanar.

3. The masking system of claim 1 wherein a physical location of the first track is offset from the second track.

4. The masking system of claim 1 wherein the motor is configured to drive the one or more linear actuators to reciprocate the second rod along at least a portion of the second track concurrently with the first rod along at least a portion of the first track.

5. The masking system of claim 1 wherein the one or more environmental sensors is a light sensor to measure ambient light.

6. The masking system of claim 1 wherein the one or more environmental sensors is a motion sensor.

7. The masking system of claim 1 wherein the one or more environmental sensors is a temperature sensor.

8. The masking system of claim 1 wherein the one or more environmental sensors is a carbon dioxide sensor to detects and measures a concentration of carbon dioxide gas.

9. The masking system of claim 1 wherein the first panel and the second panel are made of a flexible material configured to be stretched

10. The masking system of claim 1 wherein the first panel and the second panel are made of a rollable material configured to be rolled.

11. The masking system of claim 1 wherein the first track has a radiused curvature and the second track is substantially planar.

12. The masking system of claim 1 wherein the second track has a radiused curvature and the first track is substantially planar.

13. The masking system of claim 1 further comprising:
a locking mechanism configured to connect a first frame of a first linear actuator of the one or more linear actuators to a second frame of a second linear actuator of the one or more linear actuators.
